(19) United States
(12) Patent Application Publication
(10) Pub. No.: US 2024/0000642 A1
(43) Pub. Date: Jan. 4, 2024

(54) LEVER DRIVETRAIN SYSTEM

(71) Applicant: GLOBAL RESEARCH INNOVATION AND TECHNOLOGY, INC., Medford, MA (US)

(72) Inventors: Benjamin Michael Judge, Somerville, MA (US); Natasha K. Scolnik, Culver City, CA (US)

(21) Appl. No.: 18/039,605

(22) PCT Filed: Dec. 10, 2021
(86) PCT No.: PCT/US2021/062933

§ 371 Date: May 31, 2023

Related U.S. Application Data
(60) Provisional application No. 63/205,456, filed on Dec. 12, 2020.

(51) Int. Cl. A61G 5/02; A61G 5/10

(52) U.S. Cl. CPC A61G 5/025; A61G 5/1035

(57) ABSTRACT

The present invention comprises of a lever drivetrain device for control of a vehicle generally including at least one lever shaft with a repositionable scrub brake to inhibit motion of the wheel. The lever shaft is demountably coupled to a receiver via a socket secured to a gear of a gear assembly. The lever permits a multitude of hand positions to vary effort. The scrub brake is demountably coupled to the lever shaft and can be located at a multitude of positions to vary braking load and lever engagement position. In some embodiments, the scrub brake is comprised of material of high coefficient of friction and optimized geometry for braking performance and service.

### CROSS-REFERENCE TO RELATED APPLICATION

This application claims the benefit under 35 U.S.C. § 119(e) of U.S. Provisional Patent Application Ser. No. 63/205,456, filed Dec. 12, 2020, which is hereby incorporated herein by reference in its entirety for all purposes.

### FIELD OF THE INVENTION

The present invention relates to levers and associated interfaces that variably actuate and/or control. More particularly, the disclosure relates to a multi-function lever that has multiple positions and materials for the load, effort, and fulcrum to optimize the actuation and/or control as the lever interfaces with machines such as drivetrains and the like and/or systems such as human powered vehicles and the like.

### BACKGROUND

There is a long development history of innovation within the field of human powered vehicles. Classic examples, such as the bicycle, are the canonical machine for efficient human transportation. However, there are those that are unable to use a standard bicycle, such as persons with disabilities. If said person has limited use of their legs, they will often elect to use a seated wheeled carriage, such as a wheelchair.

The standard wheelchair, while mature and simple in design, is inefficient for traveling long distances or over variable terrain. Additionally, push-rim wheelchair propulsion is susceptible to repetitive stress injury. Recently, lever driven wheelchairs have been developed to address these shortcomings. While many designs take advantage of improved mechanical advantage, lever wheelchair design is still immature with many needs of persons with disabilities yet to be addressed such as effort optimization, ergonomics, and improved effectiveness and actuation of controls such as brakes.

Certain lever wheelchairs integrate the lever mechanism into the main wheel. While modular such that it can be added to most standard wheelchairs, this type of design is complicated, heavy, expensive, and braking is compromised by being not intuitive and/or engaged by weaker arm muscles. Other lever controls of lever wheelchairs, while configured from simpler bicycle components, have a fixed hand position so that the user can operate a hand brake, which is difficult for some that have limited grip strength and limits the gearing to only one ratio. Finally, examples exist with improved fulcrum position and variable mechanical advantage via multiple hand positions on the lever rotatable in a defined plane, such as a plane parallel to a saggital plane of the user of the vehicle. This permits intuitive and optimal torque for engaging the drivetrain load and a reverse motion can engage brake load. However, this type of lever chair has a fixed lever push and braking pull position relative to a rider's chest, which is not ideal for some different or changing width and girth riders or riders that want to adjust these parameters with simple field tools and without complicated disassembly. Additionally, one method of braking is integrating a cantilevered scrub brake on the lever itself, which allows for quick axial release of the wheel (opposed to high performance bike rim or disc brakes that capture the braking surface). While the lever-based scrub brake can be fabricated of the same material and finish as the lever, they do not have optimal stopping performance, particularly in wet weather. Nor are they easily serviceable.

Therefore, a need exists in the field of human powered vehicles for those humans to be able to propel, brake, steer, and otherwise control a vehicle with as little effort possible for optimal efficiency and performance. An additional need is to make these accommodations easily and with field tools, such that many humans can use the same vehicle platform. Finally, human powered vehicles, such as lever wheelchairs, need novel lever devices and apparatuses capable of variable load, effort, and fulcrum configurations to accommodate for the variety of strength, size, and ergonomic factors of humans.

### SUMMARY

The present invention comprises of a novel lever drivetrain device for control of a vehicle generally including at least one lever shaft with a scrub brake to inhibit motion of the wheel. The lever shaft may include a locating pin and is demountably coupled to a gear of a gear assembly via a socket with slot. The socket includes a slot to receive the locating pin. The lever permits a multitude of hand positions to vary effort required by the user. The receiver is mounted to fulcrum bearings attached to the vehicle frame. The receiver socket can be exchanged to be aligned at a multitude of angles relative to the frame for preferred alignment with rider ergonomics. Additionally, the scrub brake is demountably coupled to the lever shaft and can be located at a multitude of positions to vary braking load and lever engagement position. Furthermore, in some embodiments, the scrub brake is comprised of material of high coefficient of friction and optimized geometry for braking performance and service. In preferred embodiments, the lever coupling engages with the drivetrain load, such as a bicycle transmission chain drive of chainring, chain, and sprocket. The receiver bearings can be adjusted in distance from the drive wheels to vary the fulcrum. For example, the receiver position can be varied for a optimal fulcrum position. In some embodiments, this fulcrum is fixed to the seatpan of the vehicle and fixed relative to the seated rider. The whole seatpan can move relative to the wheel frame by changing the number of links in the chain, which also changes the combined center of gravity of the vehicle and the rider. The size of the seatpan may also be adjusted. The seatpan's slots permit the tensioning of the chain. Preferred embodiments of the receiver include a multi-part assembly for different lever angles, including a lockout for using it as a left or right handed part. Finally, preferred embodiments of the scrub brake bar are located with a series of holes in the lever. The hand positions of the lever can be augmented by soft grip material for user fatigue considerations.

In accordance with one or more aspects, a drivetrain assembly configured to propel a vehicle and to brake rotation of a wheel supported on an axle of the vehicle is provided. The drivetrain assembly may comprise a drivetrain and a lever constructed and arranged in actuating engagement with the drivetrain. The lever may be defined as user configurable in position relative to the drivetrain at a plurality of fulcrum and/or actuation plane positions.

In some aspects, the drivetrain is configured to receive the lever at a predetermined angle. The lever may be adjustably receivable along a length of the lever by a socket of the drivetrain. The socket may be constructed and arranged to receive the lever at a predetermined angle. The socket of the drivetrain may be interchangeable with a first socket defining a first predetermined angle and a second socket defining a second predetermined angle.

In some aspects, the assembly may further comprise a brake. The brake may be removably receivable by the lever. The lever may be constructed and arranged to receive the brake at two or more positions along its length. The brake may be defined by a geometry having a plurality of orientations. The lever may be made of a first material and the brake may be made of a second material. The second material may be defined by a coefficient of friction of at least about 0.3.

In accordance with one or more aspects, a wheelchair is provided. The wheelchair may comprise any of the drivetrain assemblies including levers and/or brakes as described herein.

In some aspects, the lever is a first lever and the assembly of the wheelchair further comprises a second lever. The wheelchair may further comprise an adjustable seat.

In accordance with one or more aspects, a method of facilitating operation of a wheelchair by a user is disclosed. The method may comprise providing a wheelchair as described herein and performing one or more steps of: adjusting an angle at which the lever is received by the drivetrain, adjusting a longitudinal position at which the lever is received by the drivetrain, and adjusting an angle of engagement for the brake.

In some aspects, the method may further comprise evaluating at least one parameter of the user. A shoulder span of the user may be measured and one or more of the adjustment steps may be based on the measured shoulder span. The wheelchair may be adjusted to generally align at least one lever with shoulders of the user. The method may further comprise reevaluating the at least one parameter of the user and readjusting the wheelchair in view thereof. In some aspects, at least one of the adjustments may be based on a first intended mode of operation and the method may further comprise reconfiguring the wheelchair for a second intended mode of operation.

In accordance with one or more embodiments, a drivetrain assembly may be configured to propel a vehicle and to brake rotation of a wheel supported on an axle of the vehicle. The drivetrain assembly may comprise a socket including an outer wall defining a recess, two spaced apart segments of the outer wall defining a longitudinal slot, one of the spaced apart segments including a plurality of lobes defining a transverse slot. The assembly may further comprise a lever including a longitudinally extending main body made of a first material, the main body including a handle at a first end of the main body, a plurality of mounting holes toward a middle of the main body, and an outwardly extending pin toward a second end of the main body, the pin being configured to allow relative longitudinal movement of the socket and the main body of the lever when the pin is received in the longitudinal slot of the socket and the pin being configured to prevent relative longitudinal movement of the socket and the main body of the lever when the pin is received in the transverse slot of the socket. The assembly may further comprise a brake bar selectively securable at one of the plurality of mounting holes, the brake bar being made of a second material different than the first material. The assembly may still further comprise mounting hardware configured to secure the brake bar to the main body at the one of the plurality of mounting holes.

In some aspects, the material of the brake bar may be selected to optimize the braking coefficient when the brake bar engages the wheel. The brake bar may include a portion having an outer surface that is at least substantially cylindrical. The plurality of mounting holes may include at least five mounting holes. The brake bar may be securable to the main body of the lever by a threaded fastener secured around a saddle washer. The socket may be configured to receive the lever at a predetermined angle.

In some aspects, the handle may include a hand grip secured to the main body of the lever. The hand grip may include an outer surface having a portion that is textured. The hand grip may be made of a material that is softer than the material of the main body of the lever. The recess in the socket may include a closed end. The closed end of the recess may be closed by at least one of a plug, a step, tape, a weld, or another feature.

In some aspects, the socket may be secured to a spider that is configured to be secured to the axle. A position of the spider may be adjustable and the socket may be secured to the spider at a fastening point. A fastener may extend through a lower end of the recess in the socket to secure the socket to a spider at the fastening point. A position of the fastening point may be adjustable. The socket may be mounted on a bearing secured to a frame of the vehicle. A distance between the bearing and the drive wheel may be adjustable. The lever may be configured to be selectively mounted for one of left handed use or right handed use. The socket may be replaceable with a socket having a transverse slot positioned a greater distance from the at least one fastening point of the socket.

In accordance with one or more aspects, a wheelchair may comprising any of the assemblies described herein.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 is a perspective view of one example of an adjustable lever system lever and scrub brake according to various embodiments of the present invention;

FIG. 2 is a perspective view of one example of an adjustable lever system receiver coupling with square alignment according to various embodiments described herein;

FIG. 3 is a side profile view of embodiment of an adjustable lever system in the complete lever assembly of a human powered vehicle with lever removed and socket removed from receiver according to various embodiments described herein;

FIG. 4 is a perspective view of one example of an adjustable lever system receiver coupling with angled alignment according to various embodiments described herein;

FIG. 5 is a front profile view of embodiment of an adjustable lever system in the complete lever assembly of a human powered vehicle depicting levers adjusted in different planes by utilizing different sockets according to various embodiments described herein;

FIG. 6 is a side profile view of an embodiment of an adjustable lever system in the complete lever assembly of a human powered vehicle according to various embodiments described herein;

FIG. 7 is a perspective view of an embodiment of an adjustable lever system in the complete lever assembly of a human powered vehicle with wheels removed according to various embodiments described herein;

FIG. 8 is a perspective view of an embodiment of a human powered vehicle utilizing a lever system to engage the drivetrain according to various embodiments described herein;

FIG. 9A is a side view of an embodiment of a human powered vehicle utilizing a lever system of the present disclosure, with the brake bar in a first position along the lever arm;

FIG. 9B is a side view of an embodiment of a human powered vehicle utilizing a lever system of the present disclosure, with the brake bar in a second position along the lever arm;

FIG. 9C is a side view of an embodiment of a human powered vehicle utilizing a lever system of the present disclosure, with the brake bar in a third position along the lever arm;

FIG. 9D is a side view of an embodiment of a human powered vehicle utilizing a lever system of the present disclosure, with the brake bar in a fourth position along the lever arm;

FIG. 9E is a side view of an embodiment of a human powered vehicle utilizing a lever system of the present disclosure, with the brake bar in a fifth position along the lever arm;

FIG. 9F is a side view of an embodiment of a human powered vehicle utilizing a lever system of the present disclosure, with the brake bar in a sixth position along the lever arm; and

FIG. 10 is a schematic view of another embodiment of a socket for use in a lever system of the present disclosure.

### DETAILED DESCRIPTION

The terminology used herein is for the purpose of describing particular embodiments only and is not intended to be limiting of the invention. As used herein, the term “and/or” includes any and all combinations of one or more of the associated listed items. As used herein, the singular forms, “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will further be understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New adjustable lever systems, devices, apparatuses, and methods for operating levers controlling human powered devices are discussed herein. In the following description, for purposes of explanation, numerous specific details are set forth in order to provide a thorough understanding for the present invention. It will be evident, however, to one skilled in the art that the present invention may be practiced without these specific details.

The present disclosure is to be considered as an exemplification of the invention, and is not intended to limit the invention to the specific embodiments illustrated by the figures below.

The lever drivetrain system of the present disclosure is configured to allow a user to selectively propel and brake one or more wheels of a vehicle. In some embodiments, the vehicle is a personal mobility device. In some embodiments, the personal mobility device is a wheelchair, such as a wheelchair disclosed in U.S. Pat. No. 8,844,959, titled “Wheelchair with Lever Drivetrain,” and issued on Sep. 30, 2014, or U.S. Pat. No. 9,644,730, titled “Demountable Coupling System and Apparatus,” issued on May 9, 2017, each of which is hereby incorporated by reference herein in its entirety for all purposes. The wheelchair may include one or more wheels that is configured to be selectively propelled or braked by an embodiment of the lever drivetrain system of the present disclosure. Various wheels commonly to those skilled in the art may be implemented. In some embodiments, the vehicle may include solid wheels. In some embodiments, the vehicle may include wheels including solid hubs and rims, with tires mounted on the rims. In some embodiments, the tires may be pneumatic (air-filled) tires or solid tires.

Generally, the lever drivetrain system includes a gear subassembly connected to a wheel of a vehicle and a lever subassembly configured to propel the wheel via the gear subassembly or brake the wheel by engaging a surface of the wheel.

Gear subassemblies are generally commonly known and understood by those of ordinary skill in the mechanical arts. The gear subassembly may include a sprocket gear, a chain, and a chain gear (or spider, or drive gear). The sprocket gear is rotatably secured to an axle of a vehicle. The axle is secured to a wheel of the vehicle, so that rotation of the sprocket gear causes rotation of the axle and the wheel. The sprocket is rotatable by the chain that engages the spider gear. By rotating the lever assembly, which is secured to the spider gear by a socket as described below, the user may rotate the spider gear in a first direction to cause the chain to rotate the sprocket to propel the vehicle forward.

The sprocket and the spider gear may include a number of teeth selected to provide desired performance of the gear subassembly.

The chain may be formed as any chain suitable for driving gears. In some embodiments, the chain is configured as a bicycle chain.

In accordance with one or more embodiments, the lever subassembly includes a lever arm and a brake bar. The lever arm is configured to be rotated by a user in a first direction to propel the wheel of the vehicle. The lever arm is configured to be rotated by a user in a second direction, opposite the first direction, to cause the brake arm to engage the wheel to decelerate the wheel or to hold the wheel in a fixed orientation.

The lever arm has a lower end that is configured to be received in the socket and an upper end that is configured to be gripped by the user. The main body of the lever arm may be made of any material suitable for the intended purpose. In some embodiments, the lever arm is made of a longitudinally extending metal core. In some embodiments, a cushioned handle is provided over the metal core at the upper end of the lever arm to provide a more comfortable gripping surface for the user. In some embodiments, the handle has an outer surface that is textured to provide an improved gripping surface for a user.

The lever arm may generally be sized and shaped to accommodate a range of potential users and/or to promote ergonomic operation. In some embodiments, the upper end of the lever arm includes a joint so the handle may be pivoted to an ergonomic orientation for the user to grip the handle. For example, the joint may allow the handle to be pivoted inwardly towards a central longitudinal axis of the vehicle.

The lower end of the lever is generally configured to be removably and adjustably received in a socket for flexibility to accommodate a range of users. Various approaches for nesting the lower end of the lever with the socket may be implemented. In some embodiments, the lower end of the lever arm includes a cylindrical outer surface and a pin extending from the outer surface. In such embodiments, the cylindrical outer surface may be received within a cylindrical recess defined in the socket, and the lever may be rotated about a longitudinal axis of the recess to align the pin with an engagement surface on the socket. The socket may include one, two or more recesses so that the lower end of the lever may be strategically received by the socket so as to manipulate the vertical reach of the lever as described herein.

The socket may generally be configured to secure the lever to the gear assembly in an orientation in which the handle of the lever is at an ergonomic position for the user to comfortably control movement of the lever to propel the wheel and to apply braking to the wheel. For example, in some embodiments, the socket is configured to support the lever so the handle of the lever is in line with a user's shoulder. In at least some embodiments, lever orientation may generally be correlated to a user's shoulder span. For example, in embodiments involving left and right levers, the corresponding sockets may be constructed and arranged to position the levers such that their handles are in a spaced apart relationship which generally matches a user's shoulder span. In some embodiments, the socket is configured to orient the lever at an angle with respect to a plane perpendicular to a rotational axis of a gear in the gear assembly. In some embodiments, the socket is configured to orient the lever parallel to the plane of the gear in the gear assembly. For example, levers oriented at inward angles may be used to accommodate smaller shoulder spans while levers oriented substantially vertically may be used in connection with wider shoulder spans. In at least some embodiments, the socket is removable and replaceable to accommodate the needs and or preferences of an intended user. A first socket may be configured to position a lever at a first angle and a second socket may be configured to position the lever at a second angle.

The brake bar is configured to provide optimized frictional braking of the wheel when an outer surface of the brake bar engages an outer surface of the wheel due to rotation of the lever arm. The brake bar may be made of a material different from that of the lever body. In some embodiments, the brake bar is made of a material that is selected to optimize the braking coefficient between the brake bar and the material of the wheel. In some embodiments, the brake may be made of a material defined by a coefficient of friction of at least about 0.3. In some specific but non-limiting embodiments, the brake may be made of aluminum. Any significant decline with respect to the coefficient of friction of the brake when wet is undesirable. For example, aluminum uniquely has a less precipitous coefficient of friction drop-off with wet rubber in comparison to steel. The outer surface of the brake bar may be selected to provide a desired surface area engagement of the brake bar with the wheel. In some embodiments, the brake bar is substantially cylindrical.

To allow for different braking performance as discussed below, the brake bar is configured to be securable at various locations along the length of the lever arm. In some embodiments, the brake bar is securable to at least two locations along the length of the lever arm. In some embodiments, the brake bar is securable to at least three, four or five locations along the length of the lever arm. In some embodiments, the brake bar is securable to six or more locations along the length of the lever arm. In at least some embodiments, a slot allows for infinite securable locations for the brake along the lever arm.

The lever drivetrain of the present disclosure provides various advantages. The lever drivetrain of the present disclosure allows for ergonomic operation of the lever drivetrain by users of different sizes. The lever drivetrain is reconfigurable from a first configuration in which the lever drivetrain is configured for ergonomic operation by a first user to one or more additional configurations in which the lever drivetrain is configured for ergonomic use by another respective user or to accommodate a single user in varying states. In some embodiments, one or more parameters of the lever drivetrain may beneficially be reconfigured as the needs or preferences of a single user change over time. For example, the user's ergonomic requirements may change over time due to changes in the user's size, weight, strength or ability. The lever drivetrain may likewise be configured for operation in different desired modes of operation, for example first and second modes of operation each having different requirements.

The operation of the lever of the present disclosure is more ergonomic when the handle of the lever is in line with the user's shoulder. When the user is operating a vehicle having two levers of the present disclosure, ergonomic positioning of the levers is enabled when the handle of each lever is laterally and vertically in line with the user's respective shoulder. Different users have different widths between their shoulders. Accordingly, the lever drivetrain may be fitted to a specific user as discussed in more detail below.

Another advantage of the lever drivetrain of the present disclosure is that the lever drivetrain includes a lever assembly that includes a lever arm and a brake bar that are selectively securable to each other. A user may secure the brake bar at one of various positions along the length of the lever arm so the brake bar engages the wheel of the vehicle at one of various angles. As the lever arm is rotated, the tangential direction along the arc of movement of the brake bar at the instant the brake bar engages the wheel may be referred to as the engagement direction of the brake bar. By adjusting the position of the brake bar along the lever arm, the user may change the engagement direction of the brake bar from a direction that is near a radial direction of the wheel at the location where the brake bar engages the wheel to a direction that is near a tangential direction of an outer surface of the wheel at the location where the brake bar engages the wheel. When the engagement direction is near the radial direction of the wheel, the brake bar brakes with a wedging action into the outer surface of the wheel. This wedging engagement is useful for braking the wheel in fixed orientation when the vehicle is positioned on an inclined surface. When the engagement direction is near the tangential direction of the outer surface of the wheel, there is less wedging action between the brake bar and the wheel. Wedging action may be considered worse for braking, because it results in temporary locking of the wheel orientation. However, the wedging action may provide the user with confidence that they can apply braking load all the way up to the point of skidding the tires. Some users may desire to use the vehicle in activities in which the user causes the wedging action to intentionally skid the tires on a surface.

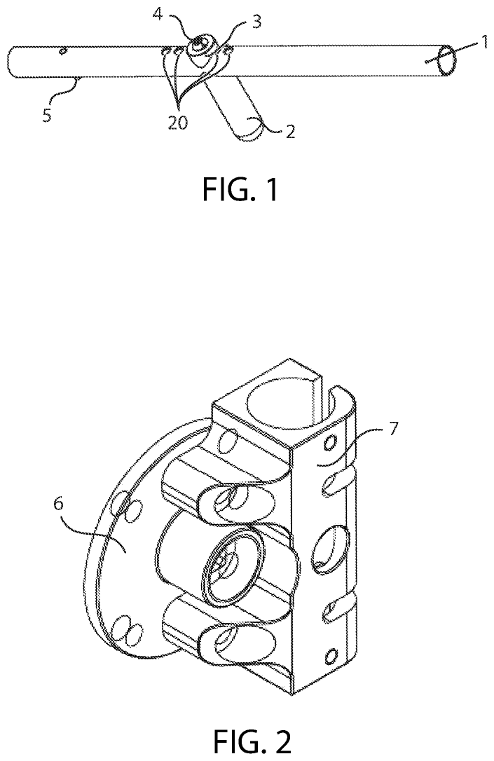

The present invention will now be described by referencing the appended figures representing preferred embodiments. FIG. 1 depicts a perspective view of the elements that may comprise an adjustable lever system (the “system”) according to various embodiments of the present invention. In preferred embodiments, each of the elements of the system are configured with at least one lever 1 on which to impart an effort at a multitude of positions, which is configured to accept scrub brake bar 2, which locates a braking load. While preferred embodiment of brake bar 2 is located by a plurality of holes 20 in lever 1 by mounting hardware 4 and saddle washer 3, other embodiments could position brake bar 2 at any location on lever 1 with other methods. As embodied in this lever system, components may be used interchangeably between mounting points, such as a system that is controlled by a human hand with left and/or right sides.

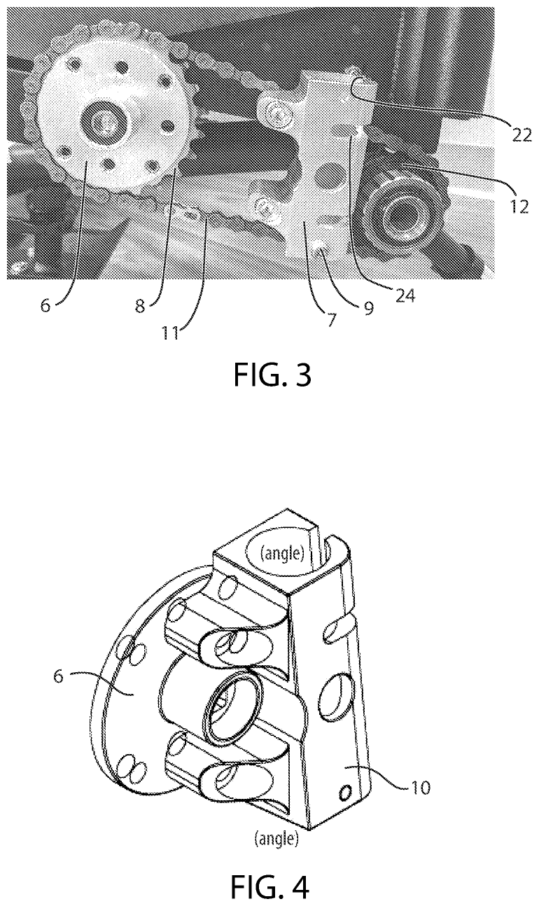

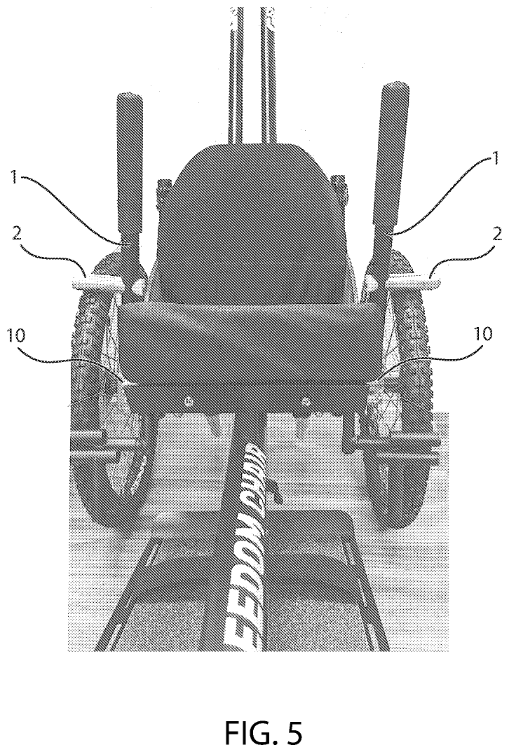

FIG. 2 depicts a perspective view of additional elements of the system that interfaces with lever 1. Socket 7 receives lever 1, with additional location and torque resistance in the preferred embodiment by a pin 5 and slot of socket 7, while other embodiments could utilize different complementary geometries. The slot of socket 7 includes a vertical slot portion 22 and a horizontal slot portion 24. Socket 7 includes a feature to block one end such that there is proper installation on the right or left side of the vehicle, increasing manufacturing order size. In this embodiment this is accomplished with a bolt 9 (of FIG. 3) but other embodiments could include a plug, step, tape, weld, or other feature to differentiate chirality after initial manufacture. Socket 7 is coupled to spider 6 in preferred embodiments with bolts that are field serviceable without removing spider 6 from the drivetrain. Spider 6 has mounting points to elements of a drivetrain, which in this preferred embodiment is a bicycle chainring 8 (of FIG. 3) and a bicycle chain 11 and sprocket 12 drive. These elements can be reconfigured to alter the drivetrain load, such as in this embodiment changing the chainring or sprocket size or tooth count.

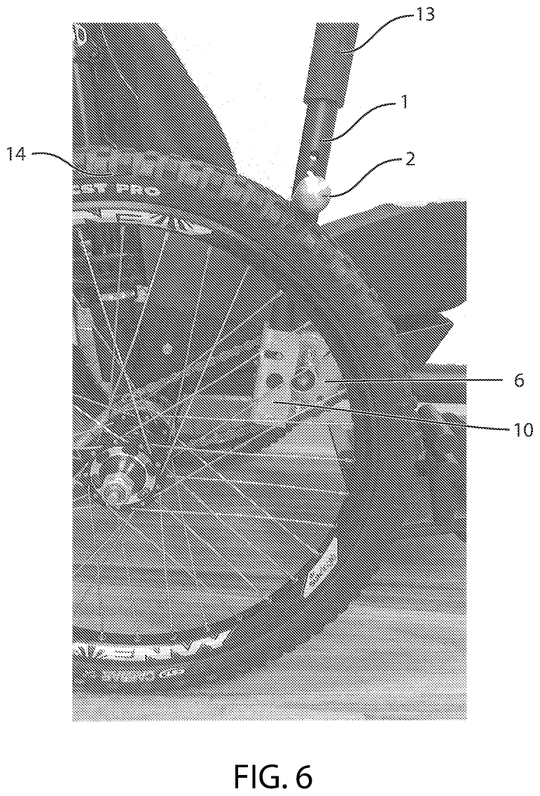

FIG. 4 depicts a perspective view of additional elements of the system that interfaces with lever 1. Socket 10 receives lever 1 similarly to socket 7, however it does so at an angle that is optimized for where the lever effort will be imparted by human manipulating the lever control, while still interfacing with spider 6. Various angles can be selected to suit an intended purpose though any wheelchair seat or other design component may limit the available range in view of potential component interference. In some embodiments, the levers may be provided at an inward angle. In other embodiments, a socket 10 analog could be configured for a plurality of angles for best ergonomics while still being field serviceable. Unlike socket 7, socket 10 may require a chiral match on the opposite side of the human powered vehicle in this particular embodiment, however one skilled in the art will understand the inventor's steps in best manufacturing practices to reduce part count and it is still within the scope of this disclosure.

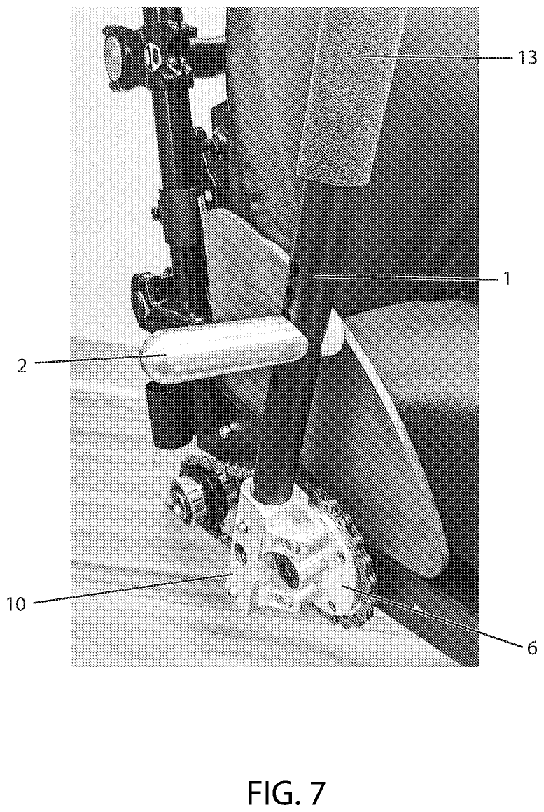

FIG. 5 illustrates the system as part of the complete vehicle comprising of different lever 1 angles accomplished with socket 7 and socket 10 in a preferred embodiment of a human powered vehicle for accommodating different width humans using the levers as controls ergonomically. Levers one can be oriented substantially vertically or at any desired inward angle to accommodate the requirements of a specific user. The space between the handles of the levers may generally be manipulated by lever orientation angle to accommodate a shoulder span of a user.

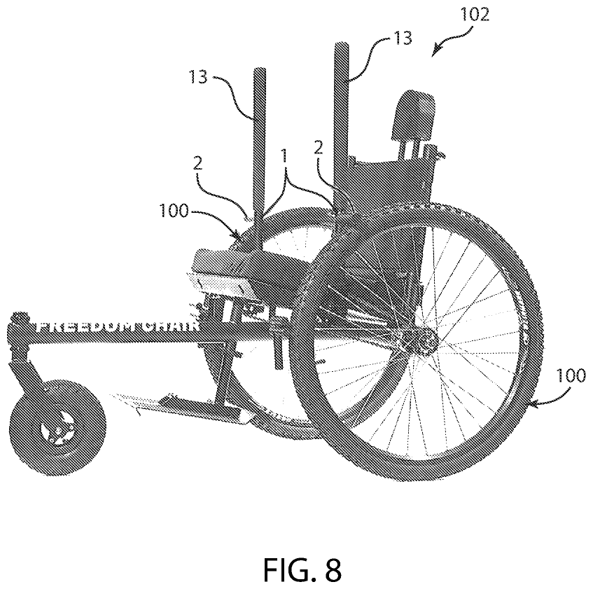

The complete adjustable lever system for drivetrain depicting improved braking and ergonomics can be additionally illustrated by FIG. 6 in a side view. In this embodiment, the lever 1 for control can be shown with a grip 13 permitting varying positions for the human effort. The scrub brake bar 2 permits axial removal of the drive wheel for quick release disassembly. The scrub brake bar 2 is separate from lever 1 and to be locatable at different positions along the lever, engaging at different points along the wheel 14. This accomplishes a variable brake load and also an optimal ergonomic position of when the brake engages relative to the human. Finally, since again lever 1 and scrub brake bar 2 are separate components the scrub brake bar 2 can be fabricated of amenable geometry for contact and composed of materials with optimal coefficient of friction against the rubber tire, particularly regarding precipitous performance drop of in common wet conditions. In this preferred embodiment, the scrub brake bar 2 is made of easy to machine aluminum, known as an improved braking surface to steel in the bicycle industry. It is replaceable as a wear component rather than being integral to the lever, and is can be reconfigured to expose another brake surface to improve its lifespan. The geometry additionally encourages wedging as a method of arresting the wheel and fit in standard lever storage as well as when the drivetrain is driven in reverse, the brake bar 2 jams to prevent further roll back, a benefit as a hill hold. Finally, the fulcrum of the spider 6 is translatable in the plane between the seat and the wheel 14, allowing for a final dimension of lever adjustability, permitting additional adjustment for humans to optimize load and effort and vary all of the interdependencies such as the center of gravity and chain tension.

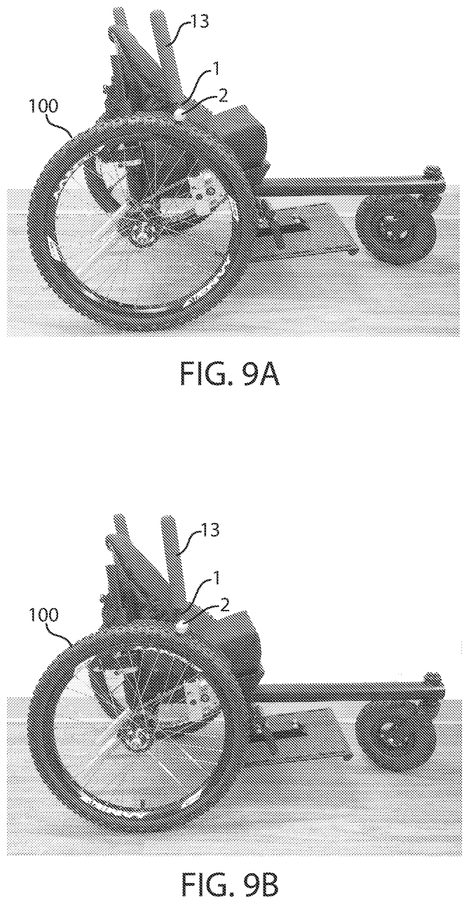

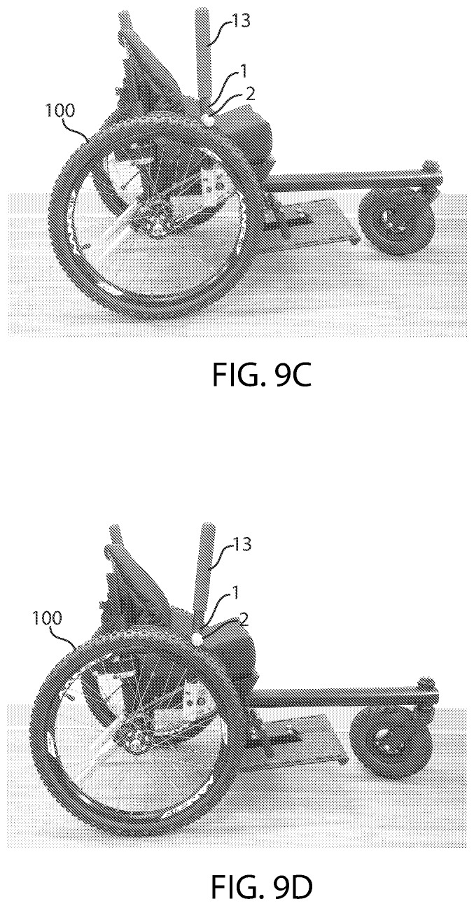

FIG. 7 provides a side profile view with of the same elements of FIG. 6, however with wheel 14 removed for clarity. FIG. 8 provides an example embodiment of a human powered vehicle 102 that utilizes a lever system for drivetrain that could benefit from adjustability for improved braking and ergonomics and gives perspective of a common platform for which is developed utility for intended use.

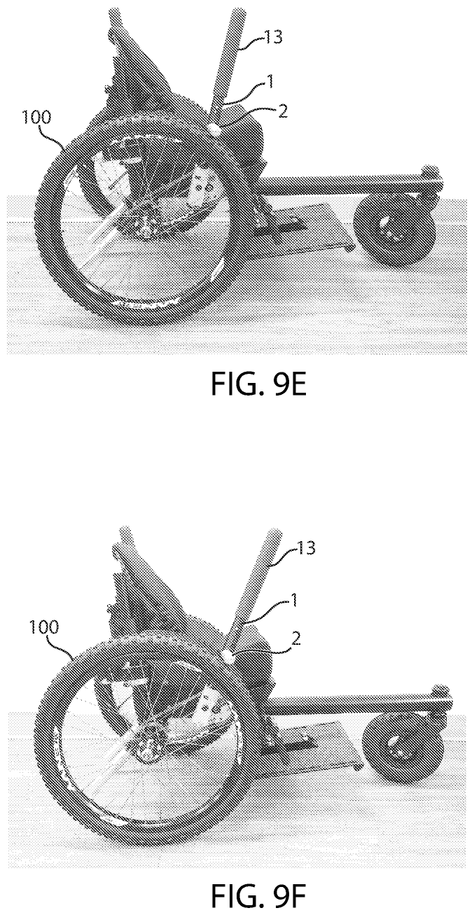

FIGS. 9A-9F depict how the location of the brake bar 2 along the length of the lever arm affects the angle at which the brake bar 2 engages the outer surface of the wheel. The lever arm includes six pin locations at which the brake bar 2 may be attached to the lever arm. The first pin location is furthest from the lower end of the lever arm, the second pin location is second furthest from the lower end of the lever arm, and so on, to the sixth pin location, which is nearest the lower end of the lever arm. In some non-limiting embodiments, the distance between the first pin and the sixth pin is about four inches.

In FIG. 9A, the brake bar 2 is at the first pin location along the length of the lever arm. The brake bar 2 engages an outer surface of the wheel 100 when the lever arm is rotated counterclockwise (as seen in the view of FIG. 9A) to a position beyond the vertical orientation of the lever arm. The brake bar 2 engages the outer surface of the wheel in a direction that is near a tangential direction of the wheel at the point of engagement. In FIG. 9B, the brake bar 2 engages the outer surface of the wheel when the lever arm is closer to the vertical orientation. In FIG. 9C, the brake bar 2 engages the outer surface of the wheel when the lever arm is closer to the vertical orientation. In FIG. 9D, the brake bar 2 engages the outer surface of the wheel before the lever arm can be rotated counterclockwise to the vertical orientation. In FIG. 9E, the brake bar 2 engages the outer surface of the wheel when the lever arm is in an even further forward orientation. Finally, in FIG. 9F, the brake bar 2 engages the outer surface of the wheel when the lever arm is in an even further forward orientation. The location of the brake bar 2 in FIG. 9F provides the greatest wedging action of the brake bar against the outer surface of the wheel.

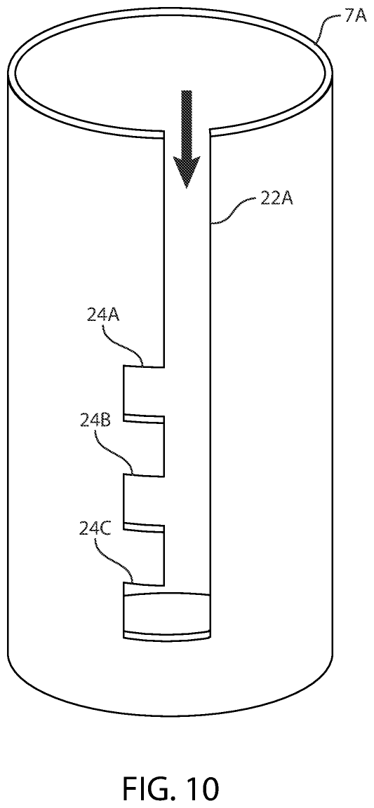

FIG. 10 depicts an alternative embodiment of a socket in which the socket includes multiple horizontal slots. The socket 7A of FIG. 10 includes a slot to engage the pin of the lever arm. The slot of socket 7A includes a vertical slot portion 22A and three horizontal slot portions 24A, 24B, 24C.

In accordance with one or more embodiments, fitting the lever drivetrain to a particular user may include determining a width between the user's shoulders and determining a height of the user's shoulders above the seat when the user is seated on the seat. Fitting the lever drivetrain to the user further includes determining the appropriate lever arm length and lever arm angle that will allow the handles of the lever arms to be aligned with the user's shoulders when the user is seated. A user or another individual may select from a set of lever arms having different lengths and may select from a set of sockets having different recess angles so the handles are aligned with the user's shoulders when the user is seated on the vehicle. The lever arm and/or socket may be interchanged as one or more user parameters or preferences change over time. Likewise, the engagement position of the lever arm in the socket can be adjusted over time to alter the effective vertical height or length of the lever. The position of the brake bar along the lever arm may also be set initially and optionally adjusted at a later time based on various operational factors. The drivetrain and vehicles embodying it are therefore highly customizable.

While preferred materials for elements have been described, the device is not limited by these materials. Wood, plastics, rubber, foam, ceramics, metal alloys, aluminum, and other materials may comprise some or all of the elements of the adjustable lever system for drivetrain in various embodiments of the present invention.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following contemplated claims.

What is claimed is:

1. A drivetrain assembly configured to propel a vehicle and to brake rotation of a wheel supported on an axle of the vehicle, the drivetrain assembly comprising:
a drivetrain; and
a lever constructed and arranged in actuating engagement with the drivetrain, the lever defined as user configurable in position relative to the drivetrain at a plurality of fulcrum and/or actuation plane positions.

2. The assembly of claim 1, wherein the drivetrain is configured to receive the lever at a predetermined angle.

3. The assembly of claim 1, wherein the lever is adjustably receivable along a length of the lever by a socket of the drivetrain.

4. The assembly of claim 3, wherein the socket is constructed and arranged to receive the lever at a predetermined angle.

5. The assembly of claim 4, wherein the socket of the drivetrain is interchangeable with a first socket defining a first predetermined angle and a second socket defining a second predetermined angle.

6. The assembly of claim 1, further comprising a brake.

7. The assembly of claim 6, wherein the brake is removably receivable by the lever.

8. The assembly of claim 7, wherein the lever is constructed and arranged to receive the brake at two or more positions along its length.

9. The assembly of claim 6, wherein the brake is defined by a geometry having a plurality of orientations.

10. The assembly of claim 6, wherein the lever is made of a first material and the brake is made of a second material.

11. The assembly of claim 10, wherein the second material is defined by a coefficient of friction of at least about 0.3.

12. A wheelchair comprising the assembly of any of the preceding claims.

13. The wheelchair of claim 12, wherein the lever is a first lever and the assembly further comprises a second lever.

14. The wheelchair of claim 12, further comprising an adjustable seat.

15. A method of facilitating operation of a wheelchair by a user, comprising:
providing the wheelchair of any of the preceding claims; and
performing one or more steps of:
adjusting an angle at which the lever is received by the drivetrain;
adjusting a longitudinal position at which the lever is received by the drivetrain; and
adjusting an angle of engagement for the brake.

16. The method of claim 15, further comprising evaluating at least one parameter of the user.

17. The method of claim 16, wherein a shoulder span of the user is measured and wherein one or more of the adjustment steps is based on the measured shoulder span.

18. The method of claim 16, wherein the wheelchair is adjusted to generally align at least one lever with shoulders of the user.

19. The method of claim 16, further comprising reevaluating the at least one parameter of the user and readjusting the wheelchair in view thereof.

20. The method of claim 15, wherein at least one of the adjustments is based on a first intended mode of operation and further comprising reconfiguring the wheelchair for a second intended mode of operation.

21. A drivetrain assembly configured to propel a vehicle and to brake rotation of a wheel supported on an axle of the vehicle, the drivetrain assembly comprising:
a socket including an outer wall defining a recess, two spaced apart segments of the outer wall defining a longitudinal slot, one of the spaced apart segments including a plurality of lobes defining a transverse slot; and
a lever, the lever including
a longitudinally extending main body made of a first material, the main body including a handle at a first end of the main body, a plurality of mounting holes toward a middle of the main body, and an outwardly extending pin toward a second end of the main body, the pin being configured to allow relative longitudinal movement of the socket and the main body of the lever when the pin is received in the longitudinal slot of the socket and the pin being configured to prevent relative longitudinal movement of the socket and the main body of the lever when the pin is received in the transverse slot of the socket;
a brake bar selectively securable at one of the plurality of mounting holes, the brake bar being made of a second material different than the first material; and
mounting hardware configured to secure the brake bar to the main body at the one of the plurality of mounting holes.

22. The wheel drivetrain propulsion assembly of claim 21, wherein the material of the brake bar is selected to optimize the braking coefficient when the brake bar engages the wheel.

23. The wheel drivetrain propulsion assembly of claim 21, wherein the brake bar includes a portion having an outer surface that is at least substantially cylindrical.

24. The wheel drivetrain propulsion assembly of claim 21, wherein the plurality of mounting holes includes at least five mounting holes.

25. The wheel drivetrain propulsion assembly of claim 21, wherein the brake bar is securable to the main body of the lever by a threaded fastener secured around a saddle washer.

26. The wheel drivetrain propulsion assembly of claim 21, wherein the socket is configured to receive the lever at a predetermined angle.

27. The wheel drivetrain propulsion assembly of claim 21, wherein the handle includes a hand grip secured to the main body of the lever.

28. The wheel drivetrain propulsion assembly of claim 27, wherein the hand grip includes an outer surface having a portion that is textured.

29. The wheel drivetrain propulsion assembly of claim 27, wherein the hand grip is made of a material that is softer than the material of the main body of the lever.

30. The wheel drivetrain propulsion assembly of claim 21, wherein the recess in the socket includes a closed end.

31. The wheel drivetrain propulsion assembly of claim 30, wherein the closed end of the recess is closed by at least one of a plug, a step, tape, a weld, or another feature.

32. The wheel drivetrain propulsion assembly of claim 30, wherein the socket is secured to a spider that is configured to be secured to the axle.

33. The wheel drivetrain propulsion assembly of claim 32, wherein a position of the spider is adjustable and wherein the socket is secured to the spider at a fastening point.

34. The wheel drivetrain propulsion assembly of claim 33, wherein a fastener extends through a lower end of the recess in the socket to secure the socket to a spider at the fastening point.

35. The wheel drivetrain propulsion assembly of claim 32, wherein a position of the fastening point is adjustable.

36. The wheel drivetrain propulsion assembly of claim 31, wherein the socket is mounted on a bearing secured to a frame of the vehicle.

37. The wheel drivetrain propulsion assembly of claim 36, wherein a distance between the bearing and the drive wheel is adjustable.

38. The wheel drivetrain propulsion assembly of claim 30, wherein the lever is configured to be selectively mounted for one of left handed use or right handed use.

39. The wheel drivetrain propulsion assembly of claim 31, the socket being replaceable with a socket having a transverse slot positioned a greater distance from the at least one fastening point of the socket.

40. A wheelchair comprising the assembly of any of the preceding claims.
